(19) United States
(12) Patent Application Publication
(10) Pub. No.: US 2009/0123744 A1
(43) Pub. Date: May 14, 2009

(54) DOUBLE-SIDED CONTACT-ADHESIVE TAPE FOR PRODUCING OR BONDING LC DISPLAYS, HAVING LIGHT-ABSORBING PROPERTIES

(75) Inventors: Marc Husemann, Hamburg (DE); Reinhard Storbeck, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/720,348

(22) PCT Filed: Dec. 2, 2005
(86) PCT No.: PCT/EP2005/056400

§ 371 Date: Jul. 11, 2007

(30) Foreign Application Priority Data
Dec. 2, 2004 (DE) 10 2004 058 280.7

(51) Int. Cl. B32B 7/12

(52) U.S. Cl. 428/354; 156/556

(57) ABSTRACT

The invention relates to a contact-adhesive tape, in particular for producing or bonding optical liquid crystal data displays (LCDs), said tape comprising an upper face and an underside. The tape also comprises a backing film (a) with an upper face and an underside, both the upper face and the underside of said tape being provided with a respective contact-adhesive layer (b, b′). The contact-adhesive layer on at least one side of the contact-adhesive tape is black.

The invention relates to double-sided pressure-sensitive adhesive tapes having multilayer carrier constructions and having light-absorbing properties for producing or for bonding liquid-crystal displays (LCDs).

Pressure-sensitive adhesive tapes in the age of industrialization are widespread processing auxiliaries. Particularly for use in the computer industry, very exacting requirements are imposed on pressure-sensitive adhesive tapes. As well as having a low outgassing behavior, the pressure-sensitive adhesive tapes ought to be suitable for use across a wide temperature range and ought to fulfill certain optical properties.

One field of use is that of LC displays, which are needed for computers, TVs, laptops, PDAs, cell phones, digital cameras, etc.

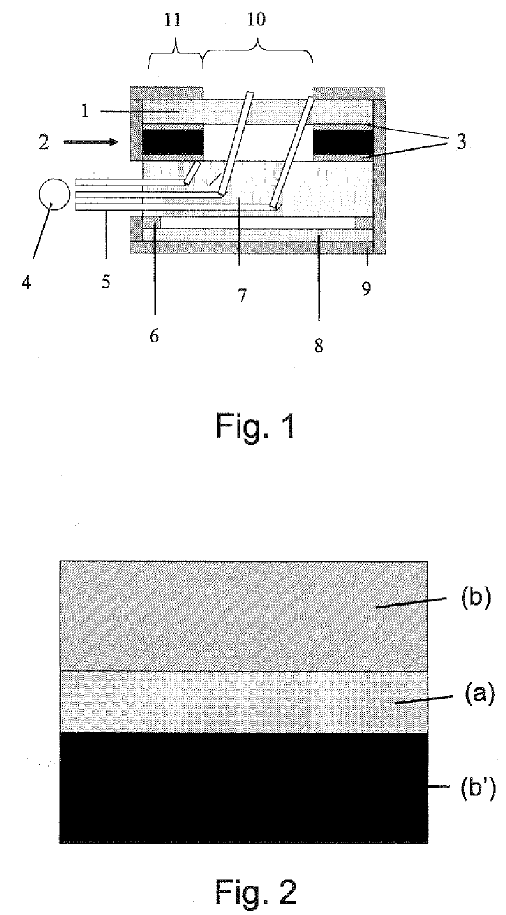

In this area, what are known as spacer tapes, which have light-absorbing functions, are very frequently used around LC displays. On the one hand, the intention is to avoid light from outside falling on the display. On the other hand, the intention is for no light coming from the light source of the LC display to penetrate to the outside. One example of such an LCD module is shown in FIG. 1.

The key to the reference numerals is as follows:
1 LCD glass
2 double-sided black adhesive tape
3 pressure-sensitive adhesive
4 light source (LED)
5 light beams
6 double-sided adhesive tape
7 optical waveguide
8 reflective film
9 LCD casing
10 visible region
11 “blind” region

At the current time there is a tendency in this industry toward more lightweight electronic devices with higher resolution and ever larger LC displays. The use of stronger and ever more efficient light sources is connected with this tendency, which in turn places higher demands on the light-absorbing properties of the adhesive tape.

In general, black double-sided adhesive tapes are used for this application. There are numerous approaches in existence for producing these adhesive tapes and the carriers necessary therefor.

One approach to the production of black double-sided pressure-sensitive adhesive tapes lies in the coloration of the carrier material. Within the electronics industry great preference is attached to using double-sided pressure-sensitive adhesive tapes having PET carriers, on account of their very good diecuttability. The PET carriers are colored with carbon black or other black pigments, in order to achieve light absorption. Such systems are currently commercially available as Tesa™ 51965, for example.

The disadvantage of this existing approach is the low level of light absorption. In very thin carrier layers it is possible to incorporate only a relatively small number of particles of carbon black or other black pigment, with the consequence that absorption of the light is incomplete. With the eye, and also with relatively intensive light sources (with a luminance of greater than 600 candelas) it is possible to determine the deficient absorption.

Another approach to producing black double-sided pressure-sensitive adhesive tapes concerns the production of a two-layer or three-layer carrier material by means of coextrusion. Carrier films are generally produced by extrusion. As a result of the coextrusion, as well as the conventional carrier material, a second and optionally also a third, black layer is coextruded, fulfilling the function of light absorption. This approach too has a variety of disadvantages. For example, for extrusion it is necessary to use antiblocking agents, which then lead to what are called pinholes in the product. These pinholes are optical point defects (light passes through these holes) and adversely impact the functioning in the LCD.

A further problem is posed by the layer thicknesses, since the two or three layers are first of all shaped individually in the die and it is therefore possible overall to realize only relatively thick carrier layers, with the result that the film becomes relatively thick and inflexible and hence its conformation to the surfaces to be bonded is poor. Moreover, the black layer must likewise be relatively thick, since otherwise it is not possible to realize complete absorption. A further disadvantage lies in the altered mechanical properties of the carrier material, since at least one black layer is coextruded, whose mechanical properties are different from those of the original carrier material (e.g., PET). A further disadvantage of the two-layer version of the carrier material is the difference in anchoring of the adhesive to the coextruded carrier material. In this case, there is always a weak point in the double-sided adhesive tape.

In a further approach, a black colored coating layer is coated onto the carrier material single-sidedly or double-sidedly. This approach too has a variety of disadvantages. On the one hand, here as well, defects (pinholes) are readily formed, are introduced by antiblocking agents during the film extrusion operation, and can also not be over-coated. These pinholes are unacceptable for the application in the LC display. Furthermore, the maximum absorption properties do not correspond to the requirements, since only relatively thin coating films are applied. Here as well, there is an upper limit on the layer thicknesses, since otherwise the mechanical properties of the carrier material would suffer alteration.

In the development of LC displays there is a trend beginning to show. On the one hand, the LC displays are to become more lightweight and flatter, and there is a rising demand for ever larger displays with ever higher resolution.

For this reason, the design of the displays has been changed, and the light source, accordingly, is coming nearer and nearer to the LCD panel, with the consequence of an increased risk of more and more light penetrating from the outside into the marginal zone (“blind area”) of the LCD panel (cf. FIG. 1). With this development, therefore, there is also an increase in the requirements imposed on the shading properties (blackout properties) of the double-sided adhesive tape, and accordingly there is a need for new approaches to the production of black adhesive tapes.

Some further patents on the prior art are listed below.

JP 2002-350612 describes double-sided adhesive tapes for LCD panels with light-protective properties. The function is achieved by means of a metal layer applied on one or both sides to the carrier film, it also being possible, additionally, for the carrier film to have been colored. However, that invention merely attempts to compensate for the cause of the pinholes by the double-sided metalization of the carrier films. Freedom from pinholes is not achieved with this approach.

JP 2002-023663 likewise describes double-sided adhesive tapes for LCD panels that have light-protecting properties. Here again, the function is achieved by means of a metal 1 layer applied on one or both sides to the carrier film. Moreover, colored adhesives are also described in the document. In analogy to JP 2002-350612, here as well attempts are only made to compensate for the cause of the pinholes by a double-sided metalization of the carrier films.

For the adhesive bonding of LCD displays and for their production, therefore, there continues to be a need for double-sided PSA tapes which do not have the deficiencies described above, or which have them only to a reduced extent.

It is therefore an object of the invention to provide a double-sided pressure-sensitive adhesive tape which as far as possible avoids pinholes in application, and which is capable of fully absorbing light.

In the context of this invention it has surprisingly been found that adhesive tapes of this kind can be produced by means of compositions colored black, in particular using specific carbon black. Of particular surprise was that an absolute black coloration was achievable even with very low rates of application of composition, so that the double-sided adhesive tape did not contain any pinholes, while at the same time the technical adhesive properties and the suitability for the production of LCD modules were retained.

The invention relates accordingly to pressure-sensitive adhesive tapes, in particular for the production or adhesive bonding of optical liquid-crystal displays (LCDs), having a top side and a bottom side, further comprising a carrier film having a top side and a bottom side, the pressure-sensitive adhesive tape being provided both on the top side and on the bottom side with in each case a pressure-sensitive adhesive layer, and the pressure-sensitive adhesive layer being colored black on at least one side of the pressure-sensitive adhesive tape.

It is especially advantageous for the light-absorbing function if the pressure-sensitive adhesive layers on both sides of the pressure-sensitive adhesive tape are colored black.

The black coloration of the colored pressure-sensitive adhesive layer or of the two colored pressure-sensitive adhesive layers is preferably produced through the presence of carbon black in the pressure-sensitive adhesive composition.

Set out below are particularly advantageous embodiments of the invention, without wishing to restrict the invention unnecessarily through the choice of examples.

The pressure-sensitive adhesive (PSA) tapes of the invention are composed in particular of a multilayer carrier material and of two identical or different pressure-sensitive adhesive compositions.

In the embodiment in accordance with FIG. 2 the inventive PSA tape is composed of a carrier film layer (a), a transparent PSA layer (b) and a nontransparent, black-colored PSA layer (b′), in particular colored with carbon black.

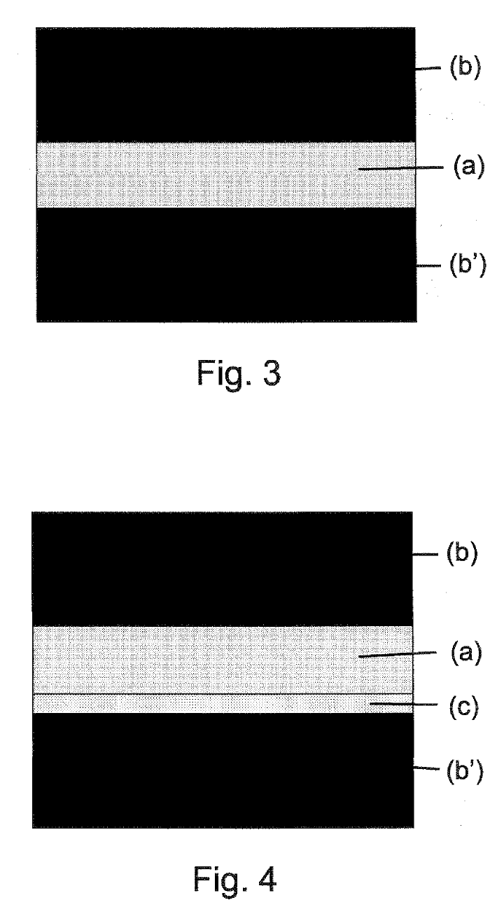

In a further advantageous embodiment the inventive PSA tape possesses the product construction shown in FIG. 3: here, the double-sided PSA tape is composed of a carrier film (a) and of two nontransparent, black PSA layers (b′), in particular colored with carbon black.

For this case of the embodiment of the invention that is depicted in FIG. 4, the double-sided PSA tape is composed of a carrier film (a), a metallically reflective layer (c), and of two nontransparent, black PSA layers (b′) in particular colored with carbon black.

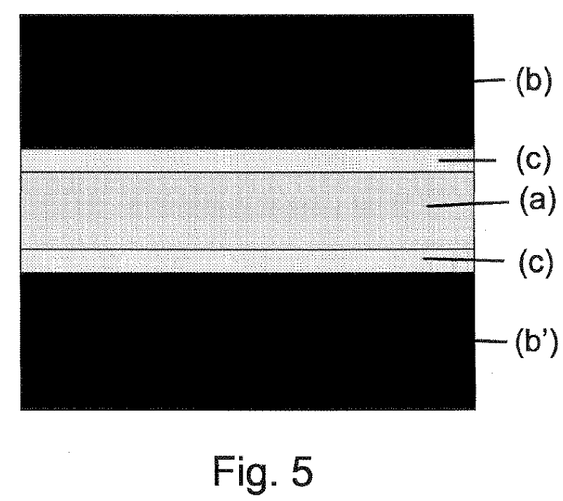

FIG. 5 shows a further embodiment of the invention, wherein the double-sided PSA tape is composed of a carrier film (a), of two metallically reflective layers (c), and of two nontransparent, black PSA layers (b′), in particular colored with carbon black.

The PSA tapes of the invention can additionally be characterized as follows:

The carrier film (a) is preferably between 5 and 250 μm, more preferably between 8 and 50 μm, most preferably between 12 and 36 μm thick and very preferably is transparent or semitransparent or of low light transmittance, as a result for example of coloring.

The layers (c) are metallically lustrous and light-reflecting. To produce the layers (c), the film (a) is vapor-coated with metal on one or both sides, such as with aluminum or silver, for example. The thickness of the layers (c) is preferably between 5 nm and 200 nm.

The PSA layers (b) and (b′) preferably possess a thickness of 5 μm to 250 μm each. The individual layers (b), (b′), and (c) may differ in thickness within the double-sided PSA tape, so that, for example, it is possible to apply PSA layers of different thickness, but it is also possible for some or all of the layers to have the same thickness, so that, for example, PSA layers of equal thickness are present on both sides of the adhesive tape, advantageously.

### Carrier Film (a)

As film carriers it is possible in principle to use all filmic polymer carriers, in particular those which are transparent. The transparency is particularly preferable for the embodiments in which a metallically reflective layer is provided.

For example, (transparent or nontransparent) polyethylene, polypropylene, polyimide, polyester, polyamide, polymethacrylate, fluorinated polymer films, etc. can be used. In one particularly preferred version, polyester films are used, more preferably PET (polyethylene terephthalate) films. The films may be present in detensioned form or may have one or more preferential directions. Preferential directions are obtained by drawing in one or in two directions. Antiblocking agents such as silicon dioxide, silica chalk or chalk, zeolites can be used for the preparation process for example for PET films.

Particularly for very thin PET films, very particularly up to 12 μm thick films, it can be very advantageous to coat the PET film on one or both sides with metal. Furthermore, the aforementioned PET films are outstandingly suitable on account of the fact that they allow very good adhesive properties for the double-sided adhesive tape, since in this case the film is very flexible and is able to conform well to the surface roughnesses of the substrates that are to be bonded.

To improve the anchoring, for example of the vapor-deposited metal, the films are preferably pretreated. The films may thus be etched (e.g., with trichloroacetic or trifluoroacetic acid), corona- or plasma-pretreated, or furnished with a primer (e.g., Saran).

Furthermore, color pigments or chromophoric particles can be added to the film material. For example, carbon black is particularly suitable for black coloring. However, the pigments or particles ought to be ever smaller in diameter than the ultimately present layer thickness of the carrier film. Optimum colorations can be achieved with 5% to 40% by weight particle fractions, based on the film material.

PSAs (b) and (b′)

The PSAs (b) and (b′) are preferably different on both sides of the PSA tape. PSA systems based on acrylate, natural-rubber, synthetic-rubber, silicone or EVA adhesives can be used in general as raw material basis.

It is of course also possible however to use all further PSAs that are known to the skilled worker, as listed for example in the “Handbook of Pressure Sensitive Adhesive Technology” by Donatas Satas (van Nostrand, N.Y. 1989).

For (b) and (b′) natural rubber adhesives can be used, for example. Here, the natural rubber is milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV grades, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made for (b) and (b′) of (meth)acrylate PSAs.

(Meth)acrylate PSAs, which are obtainable by free-radical addition polymerization, advantageously consist to the extent of at least 50% by weight of at least one acrylic monomer from the group of the compounds of the following general formula:

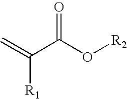

where R₁ is H or CH₃ and the radical R₂ is H or CH₃ or is selected from the group of branched or unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, N.Y. 1989).

In a further inventive embodiment the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁ is H or CH₃ and R₂ is an alkyl chain having 1-20 carbon atoms or is H.

The molar masses M_{w} of the polyacrylates used amount preferably to M_{w}≧200 000 g/mol.

In one way which is greatly preferred, acrylic or methacrylic monomers are used which are composed of acrylic and methacrylic esters having alkyl groups comprising 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 carbon atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In an advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in a further procedure, use is made for the PSA (b) of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized with a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA, as a result, for example, of extraneous light, is minimized.

For further development it is possible to admix resins to the PSAs. As tackifying resins for addition it is possible to use the tackifier resins already known and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C₅, C₉, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Express reference is made to the account of the state of knowledge in the “Handbook of Pressure Sensitive Adhesive Technology” by Donatas Satas (van Nostrand, 1989).

Here as well, the transparency of the PSA (b) is improved using, preferably, transparent resins which are highly compatible with the polymer. Hydrogenated or partly hydrogenated resins frequently feature these properties.

In addition it is possible optionally to add for the plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers. For the PSA (b) such additives may be added only in amounts which do not affect the reflection of the metallic layer.

In a further version of the invention the PSAs (b) and (b′) differ only in the black particle addition. Thus the PSA (b′) contains preferably between 2% and 30% by weight carbon black, more preferably between 5% and 20% by weight carbon black, and very preferably between 8% and 15% by weight carbon black. The carbon black has a light-absorbing function. Pigmentary carbon blacks have proven outstandingly suitable. One preferred version uses carbon black powders from the Degussa company. These powders are available commercially under the trade name Printex™. For improved dispersibility in the PSA it is particularly preferred to use carbon blacks which have been oxidatively aftertreated. For the PSA (c′), furthermore, it may be advantageous for color pigments to be added as well as carbon black. Examples of suitable additions thus include blue pigments, such as Anilinschwarz BS890 aniline black from Degussa. Matting agents as well can be used as additions.

In a further advantageous embodiment of the invention the PSAs (c) and (c′) differ not only in the black particle addition but also in terms of their chemical composition. Thus it is possible, for example, to use different polyacrylates as the base composition, differing in the comonomers and/or in the additization. Furthermore, for the layer (c′), it is also possible with advantage to make use, for example, of natural rubber or synthetic-rubber adhesives and to combine them with a transparent acrylate PSA (c). For these embodiments the PSA (c′) likewise preferably contains between 2% and 30% by weight carbon black, more preferably between 5% and 20% by weight carbon black, and very preferably between 8% and 15% by weight carbon black. The specific carbon blacks and/or color pigments specified in the section above are likewise very advantageous here.

In addition it is possible to admix crosslinkers and promoters to the PSAs (c) and/or (c′) for crosslinking. Examples of suitable crosslinkers for electron beam crosslinking and UV crosslinking include difunctional or polyfunctional acrylates, difunctional or polyfunctional isocyanates (including those in block form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add in particular UV-absorbing photoinitiators to the PSAs (b) and/or (b′). Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxy-acetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can advantageously contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

### Preparation Process for Acrylate PSAs

For the polymerization the monomers are advantageously chosen such that the resultant polymers can be used at room temperature or higher temperatures as PSAs, in particular such that the resulting polymers possess pressure-sensitive-adhesive properties in accordance with the “Handbook of Pressure Sensitive Adhesive Technology” by Donatas Satas (van Nostrand, N.Y. 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with an equation (E1) analogous to the Fox equation (E1) (cf. T.G. Fox, Bull. Am. Phys. Soc. 1 (1956) 123).

$$\frac{1}{{T}_{g}} = {\sum }_{n}^{ } \frac{{w}_{n}}{{T}_{g , n}} \qquad ( E1 )$$

In this equation, n represents the serial number of the monomers used, wₙ the mass fraction of the respective monomer n (% by weight), and T_{g,n} the respective glass transition temperature of the homopolymer of the respective monomer n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azodiisobutyronitrile (AIBN).

The average molecular weights M_{w} of the PSAs formed in the free-radical polymerization are very preferably chosen such that they are situated within a range of 200 000 to 4 000 000 g/mol; in particular, PSAs are prepared which have average molecular weights M_{w} of 400 000 to 1 400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are straight alkanes (e.g. hexane, heptane, octane, isooctane), aromatic hydrocarbons (e.g. benzene, toluene, xylene), esters (e.g. ethyl, propyl, butyl or hexyl acetate), halogenated hydrocarbons (e.g. chlorobenzene), alkanols (e.g. methanol, ethanol, ethylene glycol, ethylene glycol monomethyl ether), and ethers (e.g. diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

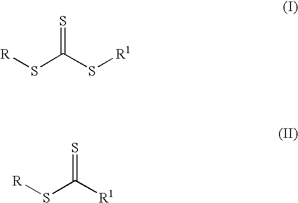

in which R and R¹ are chosen independently of one another or identical, and are
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following compounds: halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

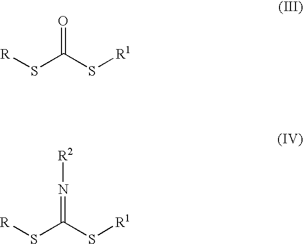

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hot-melt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

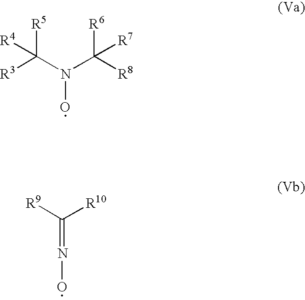

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of type (Va) or (Vb) can also be attached to polymer chains of any kind (primarily such that at least one of the abovementioned radicals constitutes a polymer chain of this kind) and may therefore be used for the synthesis of polyacrylate PSAs.

With greater preference, controlled regulators for the polymerization of compounds of the following types are selected:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethylpiperidine-1-oxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6,-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″ N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates (Hawker, Contribution to the General Meeting of the American Chemical Society, Spring 1997; Husemann, Contribution to the IUPAC World Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Coating Process, Treatment of the Carrier Material

For the preparation, in one preferred procedure the pressure-sensitive adhesive is coated from solution onto the carrier material. To increase the anchoring of the PSA it is possible optionally to pretreat the layers (a) and/or (b). Thus pretreatment may be carried out, for example, by corona or by plasma, a primer can be applied from the melt or from solution, or etching may take place chemically.

For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%.

Furthermore, the twin-screw extruder can also be used for compounding with the carbon black. In this way, the carbon black can be very finely distributed in the PSA matrix.

Further processing of the hotmelt very preferably takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, N.Y. 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels. Through the coating it is also possible for the PSAs to undergo orientation.

In addition it may be necessary for the PSA to be crosslinked. In one preferred version, crosslinking takes place with electronic and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one embodiment, it is possible to crosslink the PSAs using electron beams. Typical irradiation equipment which can be employed includes linear cathode systems, scanner systems, and segmented cathode systems, where electron beam accelerators are employed. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 to 150 kGy, in particular between 20 and 100 kGy.

It is also possible to employ both crosslinking processes, or other processes allowing high-energy irradiation.

### Metallic Layer (c)

In an advantageous procedure, for the production of a light-absorbing film, the film layer (a) is vapor-coated on one or both sides with a metal, such as with aluminum or silver, for example. In order to achieve particularly outstanding light-absorbing properties, the sputtering operation for vapor deposition should be controlled in such a way that the aluminum or silver is applied very uniformly. Moreover, in one very preferred procedure, the plasma-pretreated PET film is vapor-coated with aluminum on one or both sides in one workstep. Through the use of the layer (c), the transmittance of the light through the carrier material is further reduced or prevented, and surface roughnesses of the carrier film are compensated.

The invention further provides for the use of the inventive double-sided pressure-sensitive adhesive tapes for adhesive bonding or production of optical liquid-crystal displays (LCDs), their use for the adhesive bonding of LCD glasses, and liquid-crystal displays and devices having liquid-crystal displays having an inventive pressure-sensitive adhesive tape in their construction. For use as pressure-sensitive adhesive tape it is possible for the double-sided pressure-sensitive adhesive tapes to have been lined with one or two release films and/or release papers. Preferably use is made of siliconized or fluorinated films or papers, such as glassine, HDPE or LDPE coated papers, for example, which have in turn been given a release coat based on silicones or fluorinated polymers.

### EXAMPLES

The invention is described below, without wishing any unnecessary restriction to result from the choice of the examples.

The following test methods were employed.

### Test Methods

### A. Transmittance

The transmittance was measured in the wavelength range from 190 to 900 nm using a Uvikon 923 from Biotek Kontron. The absolute transmittance is reported in % as the value at 550 nm.

### B. Pinholes

A very strong light source of commercially customary type (e.g., Liesegangtrainer 400 KC type 649 overhead projector, 36 V halogen lamp, 400 W) is given completely lightproof masking. This mask contains in its center a circular aperture having a diameter of 5 cm. The double-sided LCD adhesive tape is placed atop said circular aperture. In a completely darkened environment, the number of pinholes is then counted electronically or visually. When the light source is switched on, these pinholes are visible as translucent dots.

### Polymer 1

A 200 l reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature.

After a reaction time of 1 h a further 40 g of AlBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture cooled to room temperature.

### Carbon Black Compound 1

In a drum, the polymer 1 is diluted to 30% solids content using special-boiling-point spirit. Subsequently 8% by weight carbon black (Printex™ 25, Degussa AG), based on the polymer 1, is mixed in with vigorous stirring. The solution is homogenized using an Ultraturrax for 10 minutes.

### Carbon Black Compound 2

In a drum, the polymer 1 is diluted to 30% solids content using special-boiling-point spirit. Subsequently 10% by weight carbon black (Printex™ 25, Degussa AG), based on the polymer 1, is mixed in with vigorous stirring. The solution is homogenized using an Ultraturrax for 10 minutes.

### Carbon Black Compound 3

In a drum, the polymer 1 is diluted to 30% solids content using special-boiling-point spirit. Subsequently 12% by weight carbon black (Printex™ 25, Degussa AG), based on the polymer 1, is mixed in with vigorous stirring. The solution is homogenized using an Ultraturrax for 10 minutes.

### Crosslinking

The carbon black compositions and the polymer 1 were coated from solution onto a siliconized release paper (PE coated release paper from Loparex), dried in a drying cabinet at 100° C. for 10 minutes, and then crosslinked with a dose of 25 kGy at an acceleration voltage of 200 kV. The coatweight was in each case 50 g/m².

### Film 1:

12 μm PET film from Mitsubishi (RNK 12 μm)

### Film 2 (Al Vapor Coating):

A commercially available 12 μm PET film from Mitsubishi RNK 12 μm was vapor coated on one side with aluminum until a complete layer of aluminum had been applied to one side. The film was vapor-coated in a width of 300 mm by the sputtering method. Here, positively charged, ionized argon gas is passed into a high-vacuum chamber. The charged ions then impinge on a negatively charged Al plate and, at the molecular level, detach particles of aluminum, which then deposit on the polyester film which is passed over the plate.

### Film 3 (Al Vapor Coating):

A normal 12 μm PET film from Mitsubishi RNK 12 μm was vapor coated on both sides with aluminum until a complete layer of aluminum had been applied to both sides. The film was vapor-coated in a width of 300 mm by the sputtering method (cf. Film 2 for this method).

### Example 1

Film 1 is coated by lamination with polymer 1 on one side and with carbon black composition 1 on the other side at 50 g/m² in each case.

### Example 2

Film 1 is coated by lamination with polymer 1 on one side and with carbon black composition 2 on the other side at 50 g/m² in each case.

### Example 3

Film 1 is coated by lamination with polymer 1 on one side and with carbon black composition 3 on the other side at 50 g/m² in each case.

### Example 4

Film 2 is coated by lamination with carbon black composition 1 on both sides at 50 g/m² in each case.

### Example 5

Film 2 is coated by lamination with carbon black composition 2 on both sides at 50 g/m² in each case.

### Example 6

Film 2 is coated by lamination with carbon black composition 3 on both sides at 50 g/m² in each case.

### Example 7

Film 3 is coated by lamination with carbon black composition 1 on both sides at 50 g/m² in each case.

### Example 8

Film 3 is coated by lamination with carbon black composition 2 on both sides at 50 g/m² in each case.

### Example 9

Film 3 is coated by lamination with carbon black composition 3 on both sides at 50 g/m² in each case.

### Results

Examples 1 to 9 were tested in accordance with test methods A and B. The results are set out in Table 1.

| | Transmittance | Pinholes |
|---|---|---|
| Example | (test A) | (test B) |
| 1 | <0.1% | 0 |
| 2 | <0.1% | 0 |
| 3 | <0.1% | 0 |
| 4 | <0.1% | 0 |
| 5 | <0.1% | 0 |
| 6 | <0.1% | 0 |
| 7 | <0.1% | 0 |
| 8 | <0.1% | 0 |
| 9 | <0.1% | 0 |

From the results in Table 1 it is apparent that examples 1 to 9 in test (A) have an extremely low transmittance of <0.1%.

In test (B) the number of pinholes was determined. Pinholes could not be found for any of the examples mentioned.

The results show that a high light yield can be achieved with the inventive adhesive tapes in the LCD application.

1. A pressure-sensitive adhesive tape comprising a carrier film having a top side and a bottom side and a pressure-sensitive adhesive layer directly or indirectly applied both on the top side and on the bottom side, wherein the pressure-sensitive adhesive layer on at least one side of the pressure-sensitive adhesive tape is colored black.

2. The pressure-sensitive adhesive tape of claim 1, which comprises pressure-sensitive adhesive layers on both sides of the carrier film, wherein the pressure-sensitive adhesive layers are colored black on both sides of the pressure-sensitive adhesive tape.

3. The pressure-sensitive adhesive tape of claim 1, wherein the black coloration of the pressure-sensitive adhesive layer(s) is brought about by means of carbon black.

4. The pressure-sensitive adhesive tape of claim 1, which comprises the following layer sequence: transparent pressure-sensitive adhesive layer (b)—carrier film layer (a)—black-colored pressure-sensitive adhesive layer (b′).

5. The pressure-sensitive adhesive tape of claim 1, which comprises the following layer sequence: black-colored pressure-sensitive adhesive layer (b′)—carrier film layer (a)—black-colored pressure-sensitive adhesive layer (b′).

6. The pressure-sensitive adhesive tape of claim 1, which comprises the following layer sequence: black-colored pressure-sensitive adhesive layer (b′)—carrier film layer (a)—metallically reflective layer (c)—black-colored pressure-sensitive adhesive layer (b′).

7. The pressure-sensitive adhesive tape of claim 1, which comprises the following layer sequence: black-colored pressure-sensitive adhesive layer (b′)—metallically reflective layer (c)—carrier film layer (a)-metallically reflective layer (c)—black-colored pressure-sensitive adhesive layer (b′).

8. A method of bonding components of an optical liquid-crystal display comprising bonding said components with a pressure-sensitive adhesive tape of claim 1.

9. The method according to claim 8, wherein the components are components of LCD glasses.

10. A liquid-crystal display device comprising a pressure-sensitive adhesive tape of claim 1.
